(19) United States
(12) Patent Application Publication
(10) Pub. No.: US 2012/0112008 A1
(43) Pub. Date: May 10, 2012

(54) SYSTEM FOR HIGH ALTITUDE TETHERED POWERED FLIGHT PLATFORM

(75) Inventors: Gregory Holifield, Eustis, FL (US); Timothy Holifield, (US); Alexander Barrett, Orlando, FL (US); Jason McKenna, Vicksburg, MS (US); Gilbert Barrett, (US); Seth Broadfoot, Vicksburg, MS (US)

(73) Assignee: Primal Innovation, Sanford, FL (US)

(21) Appl. No.: 13/211,000

(22) Filed: Aug. 16, 2011

Related U.S. Application Data
(60) Provisional application No. 61/373,950, filed on Aug. 16, 2010.

(51) Int. Cl. B64C 39/00; B64C 31/06

(52) U.S. Cl. 244/155 A

(57) ABSTRACT

A high altitude tethered platform, includes an airborne subsystem having a flight platform capable of flight. A powered propeller is mounted on the flight platform. A ground subsystem having a control system, a power delivery system, and a tether system is physically and operatively coupled to the flight platform. The tether system transmits power between the control system and the flight platform.

### CROSS REFERENCE TO RELATED APPLICATIONS

This application claims benefit to U.S. Provisional Application No. 61/373,950, filed Aug. 16, 2010.

The United States Government has rights in this invention pursuant to Contract No. W912 HZ-10-C-0043 between Primal Innovations LLC and ERDC.

### BACKGROUND OF THE INVENTION

The present disclosure relates generally to powered flight platform devices, and more particularly, to an apparatus and method for tethered high altitude sustained flight, including a sensor thereon.

Presently known unmanned tethered surveillance systems rely upon balloon flight and therefore suffer from altitude limitations. Additionally, hazardous gases, namely Helium, are required, along with a generally sizeable staff of typically five to twenty persons, and a dedicated base facility to maintain the balloon. Moreover, such lighter-than-air (LTA) operations, because they are labor intensive and require dedicated facilities, are typically very expensive to sustain, reportedly requiring a sustained $20 million annual budget. Therefore, it is readily apparent that there is a need for a high altitude tethered platform and method that overcomes the disadvantages of the prior art.

### SUMMARY OF THE INVENTION

Briefly described, in an exemplary embodiment, the present apparatus and method overcomes the above-mentioned disadvantages and meets the recognized need for such a device by providing a high altitude sustained tethered powered flight platform that is capable of maintaining indefinite, autonomous sustained flight over a finite footprint ground area, within an altitude range of 300-3000 ft above ground, including surveillance operations from high base altitude locations, and while providing real-time surveillance to a ground station, wherein take-off and landing may be completely automated.

The present system includes a platform capable of powered flight (flight platform). Video surveillance equipment and a power source may be disposed on the platform. A ground system is operatively coupled to the flight platform by a tether. The tether is capable of transmitting data and power between the flight platform and ground system. The ground system may contain a control system for operation of the flight platform and a power system.

In one embodiment, a packaging system is provided to facilitate transport and support operation of all system elements. The flight platform may be automatically launched and recovered, and is secured by the tether system, wherein the flight platform flies above the ground collecting and transmitting video surveillance data along the tether to the ground system.

### BRIEF DESCRIPTION OF THE DRAWINGS

The present disclosure will be better understood by reading the written description with reference to the accompanying drawing figures, in which like reference numerals denote similar structure and refer to like elements throughout, and in which:

FIG. 1 is a block diagram of a high altitude video surveillance system constructed in accordance with the invention;

FIG. 2 is a plan view of the high altitude video surveillance system prior to launch in accordance with one embodiment of the invention;

FIG. 3 is a perspective view of a ground system constructed in accordance with one embodiment of the invention;

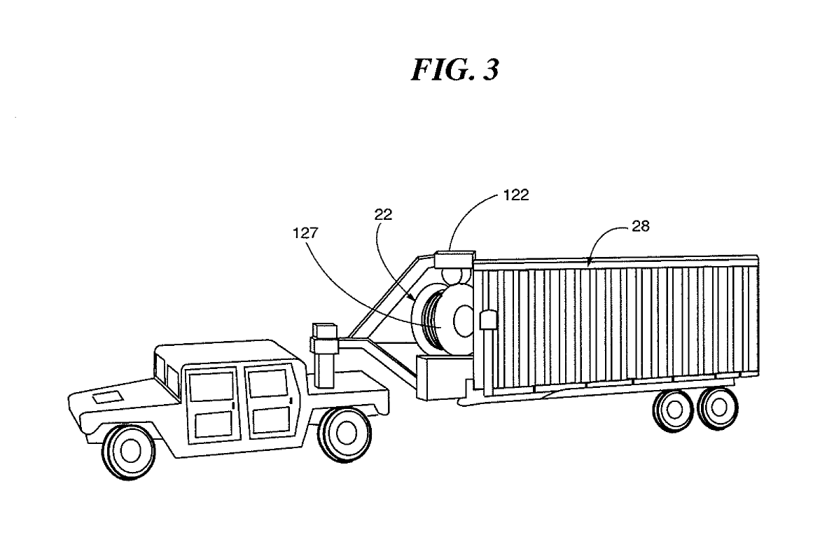

FIG. 4 is a perspective view of the control system constructed in accordance with the invention;

FIG. 5 is a perspective view of a high altitude video surveillance system constructed in accordance with another embodiment of the invention;

FIG. 6 is a perspective view of a high altitude video surveillance system constructed in accordance with yet another embodiment of the invention;

FIG. 7 is a schematic view of a high altitude video surveillance system constructed in accordance with a further embodiment of the invention; and

FIG. 8 is a perspective view of a tether assembly constructed in accordance with the invention.

### DETAILED DESCRIPTION OF THE PREFERRED EMBODIMENTS

In describing the preferred and alternate embodiments of the present disclosure, as illustrated in the figures and/or described herein, specific terminology is employed for the sake of clarity. The disclosure, however, is not intended to be limited to the specific terminology so selected, and it is to be understood that each specific element includes all technical equivalents that operate in a similar manner to accomplish similar functions.

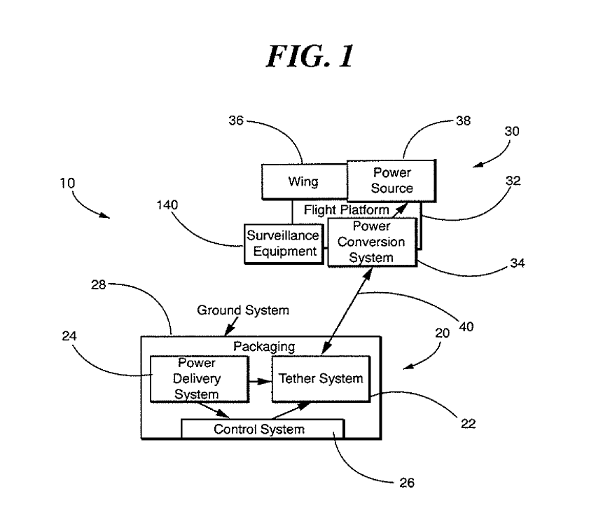

Reference is first made to FIG. 1 in which a block diagram of a high altitude video surveillance system, generally indicated as 10, and constructed in accordance with the invention, is provided. Video surveillance system 10 includes an airborne subsystem 30 for carrying the video surveillance capability to a height. A ground subsystem 20 includes the power and control systems for airborne subsystem 30 and is physically and operatively coupled to airborne subsystem 30 by a tether 40.

Airborne subsystem 30 includes a flight platform 32. Flight platform 32 is a vehicle capable of supporting surveillance equipment 140 at a height. Flight platform 32 supports a power conversion system for converting power supplied by ground subsystem 20 to power the surveillance equipment 140, and in some embodiments, a propulsion system to work in conjunction with a wing system 36. Airborne subassembly 30 is preferably a powered flight platform. Therefore, a powered flight platform 32 is includes, in a preferred but non-limiting embodiment, a propeller or rotor (as the propulsion system) to enable steering and positioning control of flight platform 32.

To provide lift to flight platform 32, a wing 36 is provided on flight platform 32. Wing 36 may include any lift mechanism known in the art, including but not limited to a fixed wing, a foil, even a rotor. It is also contemplated in at least one non-exemplary and non-limiting embodiment, that airborne subassembly 30 may make use of wind currents to generate power so that an auxiliary power source 38 may be disposed on flight platform 32.

As becomes readily apparent from the description above and description below, the claimed invention lends itself to a powered flight tethered platform. The use of video surveillance equipment is one exemplary embodiment, and other sensors, such as infrared (IR) surveillance, motion detectors, acoustic and microwave detectors and the like may be readily substituted for, or used in combination with, a video surveillance camera. Furthermore, the powered flight platform is a tethered stable platform capable of supporting a load, such that other equipment, such as, repeater antennas, communications equipment or the like may be carried thereon.

Ground subsystem 20 provides the power and control instruction to flight platform 32 and receives data such as surveillance data, in one exemplary embodiment, from flight platform 20 along tether 40. In a preferred embodiment, tether 40 includes a data coupling structure such as fiber optics, a power transfer structure such as a copper, aluminum or other electrically conductive cable, and a strengthening member to provide appropriate tensile strength to maintain sufficient tension on flight platform 32 as it is airborne.

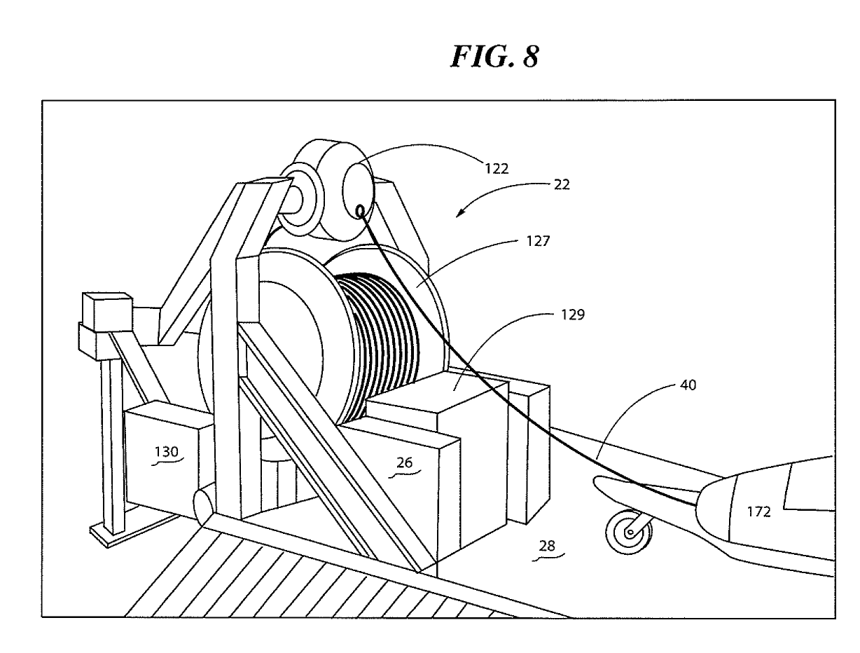

Ground subsystem 20 includes a tether system 22 for anchoring and controlling tether 40. In a preferred embodiment, tether system 22 (see FIG. 8) includes a tether guide 122 and motorized winch 127 under the control of a control system 26 for belaying out and bringing in tether 40.

A power delivery system 24 generates power and provides a power output to tether system 22. The power output is used to power tether system 22 and also is conducted along tether 40 to send power to conversion system 34 aboard flight platform 32. In a preferred, non limiting embodiment, power delivery system 24 is a high voltage high power generator, up to 10 kilowatts. In a preferred non-limiting embodiment, power conversion system 34 is a step down conversion system to condition the power output to be used by the systems of airborne subassembly 30.

Both power delivery system 24 and tether system 22 are operated under the control of control system 26 which may be part of ground subsystem 20. Control system 26 is a CPU or other computing device capable of providing controls for monitoring the operation of power delivery system 24 and tether system 22 including the receiving of data transmitted from flight platform 32 along tether 40, as well as providing operating instructions to power delivery system 24 and tether system 22. By way of example, control system 26 may output instructions to tether system 22 regarding the altitude of flight platform 32 which is controlled by the length of the extended portion of tether 40 as well as flight instructions to tether system 22 to transmit to flight platform 32 to position flight platform 32 in a desired surveillance position. Additionally, control system 26 may receive data from flight platform 32 transmitted along tether 40.

In one exemplary, but non-limiting embodiment, control system 26, tether system 22 and power delivery system 24 are all mounted on a packaging 28 which may take the form of a container, transport device or the like as will be discussed in greater detail below. However, it is also well known and understood in the art, that control system 26 may be a remote computer such as a laptop, a tablet, or any other mobile computing or stationary computing device capable of communicating either through hard wire such as fiber optic. or through a wireless link such as a cellular, radio frequency, infrared or the like with tether system 22 and power delivery system 24. Furthermore, the functionality of controlling and monitoring may be distributed as is known in the art between a very smart control system 26 and a “dumb” tether system 22 and power delivery system 24, or some of the functionality may be provided on board each of tether system 22 and power delivery system 24 as a division of the functionality.

As a result of the tethered power and powered flight of flight platform 32, a system for high altitude video surveillance 10 is capable of maintaining indefinite, autonomous sustained flight over a finite footprint ground area, within an altitude range of 300-3000 ft above a base location, including high base altitude locations above 3000 ft, and simultaneously collecting and transmit real-time video surveillance to data collection point while flying (preferably in figure eight flight path). Additionally, take-off and landing can be automated.

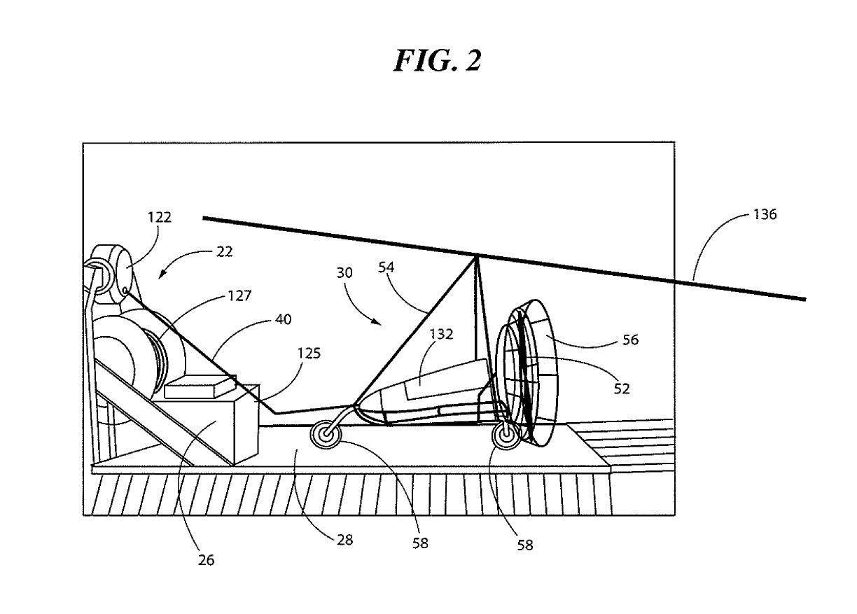

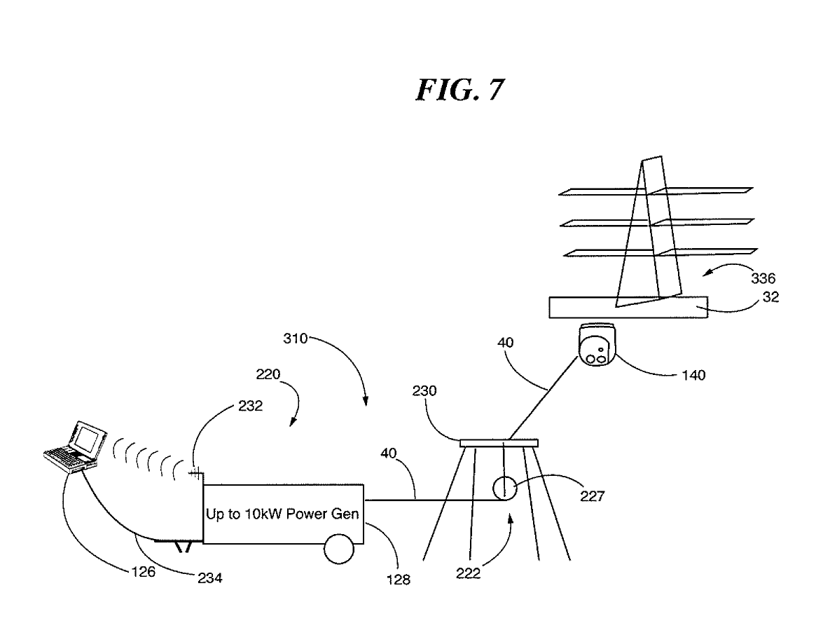

In a preferred non-limiting embodiment, surveillance system 10 includes flight platform 32 with a lifting capacity of approximately 250 lbs, video surveillance equipment (FIG. 7), a power source 38, a tether system 22, a power delivery system 24 including a generator, a control system 26, and a packaging 28 acting as a system containment unit and tether anchor. As seen in FIG. 2, in a preferred, but non-limiting embodiment, flight platform 32 is a power glider.

Flight platform 32, when in the form of a power glider, includes a housing 132 in the form of a fuselage. A wing 36 in the form of a rotor 136 is affixed to the flight platform by a tripod 54. In this embodiment, flight platform 32 includes a propeller 52 mounted on housing 136. In this embodiment, flight platform 32 may also include landing gears such as wheels 58. A protective cage 56 may be provided to protect propeller 52. While rotor 136 provides a lift, positioning is provided by rear mounted propeller 52.

As can be seen, a tether 40 couples the remainder of tether system 22 to airborne subsystem 30 providing communication between control system 26 and flight platform 32 and power to power conversion system 34, and in turn to a motor disposed within the housing of flight platform 32 to power rotor 136 and propeller 52.

Tether system 22 includes a guide 122 through which tether 40 passes on its way to the spool of a winch 127 which, in a preferred embodiment, is motorized and able to rotate in opposite directions to provide tension and slack to tether 40, to provide height to flight platform 32, as well as to reel in tether 40. In a preferred embodiment, tether 40 has a length of at least 3,000 ft. to provide sufficient height for flight platform 32 to conduct surveillance.

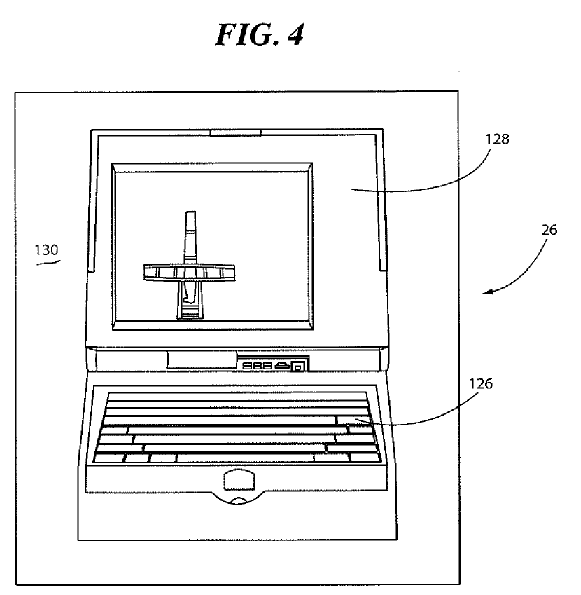

In one, exemplary but non-limiting embodiment, tether system 22 may be mounted to a packaging 28 taking the form of a flatbed of a truck. Airborne subsystem 30, prior to takeoff or after landing, may also be disposed on packaging 28 for storage and transport (see also FIG. 4).

The control system 26 may be housed on packaging 28. As seen in FIG. 4, control system 26 may include a standard input/output device such as a keyboard 126 and a display 128. It may be mounted into a wall 130 of a housing 125. As can be seen, it is well within the scope of the art, to configure control system 26 as a laptop which may either be removed from wall 130 or be entirely separate from packaging 28 communicating either by fiber optic or other transmitted hardwired communication structure or by wireless communication such as infrared, radio frequency or cellular with tether system 22 and power delivery system 24 mounted on packaging 28.

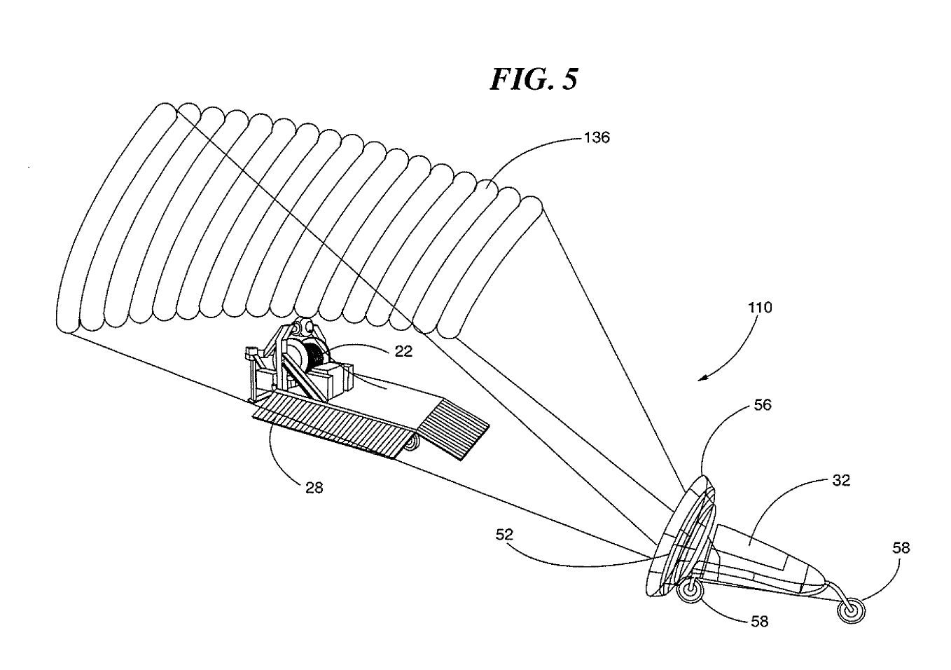

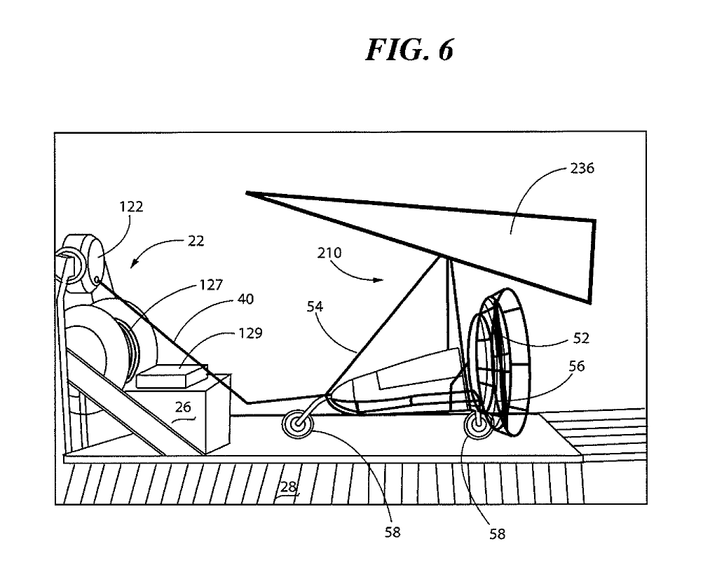

Flight platform 32 may include, by way of non-limiting example, an energy glider (FIG. 7), an aerofoil (FIG. 5), an autogyro (FIG. 2), a paraglider trike, a flexwing weight shift control aircraft (FIG. 6), an ultralight, a parafoil, a glider, or a fixed wing aircraft, or more specifically, and without limitation, an aerostat, a fixed base or mobile tower, a super power glider, a standard power glider, or an autogyro power glider. Numerous embodiments are further considered and anticipated relative to each such flight platform 32, and at least one working prototype is to include a remote controlled electric paraglider, with servos controlled via transmitter and receiver to actuate controls of the paraglider to maintain flight.

Referring to the different embodiments, more specifically, in each embodiment for ease of description, like numerals are utilized to indicate like structure. The primary difference between each embodiment is the nature of the wing for keeping flight platform 32 aloft.

Reference is first made to FIG. 5 in which a high altitude surveillance system 110 is provided. In this embodiment, flight platform 32 is supported by wing 36 which takes the specific form of an aerofoil 136. The use of an aerofoil minimizes the power requirement for system 10 by providing lift to flight platform 32 based on wind power (much like a kite) or under an assist from propeller 52 in low wind conditions. In comparison thereto, FIG. 6 shows a high altitude surveillance system 10 in which wing 36 takes on the specific form of a flex wing (such as a hang glider wing) 236.

Reference is now made to FIG. 7 in which flight platform 32 is a power glider, i.e. a glider which makes use of wind currents to generate power at flight platform 32 while in flight. In this way, the load required from a power source at the ground substation 20 is significantly reduced, if not entirely eliminated. In this embodiment, control system 26 is shown as remote from ground subsystem 20 and a tether system 222 is remote from a package 128.

In this embodiment, a system 310 includes a flight platform 32 which supports an energy glider wing 336 as known in the art. Flight platform 32 is capable of carrying surveillance equipment 140 such as a midsized (about 8″ in diameter and 10 kg in weight) Unmannned Air Vehicle (“UAV”). Tether 40 couples a ground substation 220 to flight platform 32. However, in this embodiment, tether system 222 is bifurcated and includes an aerie 230 providing a platform upon which flight platform 32 may land on or ascend from. Aerie 230 includes an aerie pulley 227 which rotates as tether 40 is let out or brought in and generates power so that the power generation functionality is on the ground rather than in the air on platform 32 to reduce weight.

A power trailer 128 houses a winch system (for controlling the length of tether 40) as well as power generation equipment.

In this embodiment, the control system 126 communicates with power trailer 128 either by wireless means through a transceiver 232 disposed at power trailer 128 or by hard wired connection such as a fiber optic link 234. It should be noted that this distribution of functionality is equally applicable to any of the embodiments of the high altitude surveillance system contemplated by the invention.

In a preferred embodiment, wing 336 is about 40 ft. wide, about 40 ft. long and the entire platform with wing weighs about 200 lbs. Sensor 140 may include a day/night camera and is capable of fiber or radio frequency communication with ground station 220 either along tether 40 (fiber optic mode) or directly to the transceiver 232 of power trailer 128 (radio frequency communication mode).

A surveillance system 310 provides several advantages in that if tether 40 breaks, the glider will gently settle to the ground as a function of the wing 336 construction. System 310 is capable of continuous operations but for the need of periodic safety and preventive maintenance and fuel for backup power for low wind operation. During low wind operation, the system is driven by being pulled along by tether 40 much like keeping a kite aloft. In winds greater than 4-10 mph, the system will drive itself and maintain itself aloft while winds of 10-40 mph will provide sufficient lift to provide power at pulley 227.

One specific, yet not limiting example of flight platform 32, with potential for system adaptability is sold under the trade name ElectraFlyer. This base flight platform 32 includes a slow turning propeller and provides for pure electric flight that is nearly silent, clean, inexpensive, and environmentally friendly, in addition to be relatively vibration free. Its long lasting, rechargeable batteries could be incorporated into the present apparatus in an alternate embodiment. Beneficial features of this existing device that may be suited for adaptation to the present apparatus include the high efficiency, 18 hp, high torque motor that is 90% efficient at cruise. Additionally, the electronic, pulse width modulated controller may be beneficially adapted, and the total weight is only 210 to 250 pounds.

In one preferred, non-limiting embodiment, the power source is an electric engine powered through an electric wire along ground-based tether 40. Alternately, the power source could be self-sustaining wind energy. The tether system, preferably Dyneema® cord or a comparably performing tether, is preferably attached to a winch system, wherein the winch system is preferably configured to reel in or let out cord or tether in order to generate power from wind energy and/or to allow for controllability of the flight platform as discussed above.

A power source 38 on flight platform is preferably utilized to convert wind energy to electric current. However, wind energy may also be used with a ground generator such as aerie pulley 227, wherein the generated electric current may be fed up tether 40 by electrical wiring to the flight platform 32.

The control system 26 preferably enables flight control of the flight platform 32 to be autonomous.

The packaging 28 (system containment unit) preferably enables the entire apparatus to be self-contained within, for example in one embodiment, a 20 ft. trailer. Although other containment options such as containers capable of air lift exist. The preferred trailer allows for ease of delivery to essentially any remote location by truck or chopper. In another embodiment, system 10 can be delivered to difficult terrain in one or more air lift containers such as container ISU 90.

In a further alternate embodiment, the present video surveillance apparatus could be configured as a kite pulling cable system, wherein a surveillance kite may be flown while attached to a series of cables and base vehicles and/or structures.

More specifically, the device of the present disclosure in its preferred form is an apparatus and method for high altitude sustained video surveillance comprising a tethered sensor platform particularly suited for conducting surveillance operations above 3000 feet, wherein power and data is transmitted to a base through the tether, and wherein the apparatus is self-contained and fully functional in diverse weather conditions, and is capable of essentially autonomous operation. The apparatus of the present disclosure preferably comprises a flight system to meet high-base altitude, persistent flight requirements, a system to deliver power to the on-board systems, including power for electric flight propulsion, and a smart tether capable of power data transmission.

What is claimed is:

1. A system for high altitude tethered powered flight, comprising:
an airborne subsystem having a flight platform capable of flight;
a propulsion system mounted on the flight platform;
a ground subsystem having a control system, a power delivery system, and a tether system, the tether system physically and operatively coupling the flight platform to the power delivery system; and the control system controlling the propulsion system and the tether system transmitting power between the power delivery system and the flight platform for powering the propulsion system.

2. The system for high altitude tethered powered flight of claim 1, further comprising a power conversion system mounted on the flight platform and operatively connected between the tether and the propulsion system for converting the power from the power delivery system for use by the propulsion system.

3. The system for high altitude tethered powered flight of claim 1, further comprising a surveillance equipment disposed on said platform.

4. The system for high altitude tethered powered flight of claim 3, wherein the surveillance equipment is a video camera.

5. The system for high altitude tethered powered flight of claim 3, wherein said surveillance equipment outputs data, said data being transmitted along said tether system to said ground sub-system.

6. The system for high altitude tethered powered flight of claim 1, wherein the control system controls the operation of the tether system.

7. The system for high altitude tethered powered flight of claim 5, wherein the control system is operatively coupled to the tether system for receiving the data.

8. The system for high altitude tethered powered flight of claim 1, wherein the tether system includes a data coupling structure between the platform and the control system.

9. The system for high altitude tethered powered flight if claim 1, wherein the tether system includes an electrically conductive tether.

10. The system for high altitude tethered powered flight of claim 1, wherein the power delivery system delivers up to 10 kilowatts to the flight platform.

11. The system for high altitude tethered powered flight of claim 1, further comprising a wing affixed to the platform.

12. The system for high altitude tethered powered flight of claim 11, wherein the wing is a foil.

13. The system for high altitude tethered powered flight of claim 1, further comprising at least a rotor affixed to the flight platform to provide lift for the flight platform, the rotor being powered by the power delivery system.

14. The system for high altitude tethered powered flight of claim 3, further comprising an auxiliary power source disposed on the flight platform, the auxiliary power source providing power to at least one the surveillance equipment and propulsion system.

15. A system for high altitude tethered powered flight of claim 1, wherein the propulsion system is a propeller.

16. The system for high altitude tethered powered flight of claim 1, further comprising a package, the ground sub-system being contained within the package.

17. The system for high altitude tethered powered flight of claim 16, wherein the package is mobile.

18. The system for high altitude tethered powered flight of claim 17, wherein the package includes a flat bed truck.

19. A system for high altitude tethered surveillance tethered power flight, comprising:
an airborne subsystem having a flight platform capable of flight;
a propulsion system mounted on the flight platform;
surveillance equipment disposed on said flight platform;
a ground subsystem having a control system, a powered delivery system, and a tether system physically and operatively coupling the flight platform to the powered delivery system; and the control system controlling the propulsion system and the tether system transmitting power between the power delivery system and the flight platform.

20. The system for high altitude tethered powered flight of claim 19, wherein the surveillance equipment is a video camera.

21. The system for high altitude tethered powered flight of claim 19, wherein said surveillance equipment outputs data, said data being transmitted along said tether system to said ground sub-system.

22. The system for high altitude tethered powered flight of claim 19, wherein the control system is operatively coupled to the tether system for receiving the data.
